(19) United States
(12) Patent Application Publication
(10) Pub. No.: US 2006/0097568 A1
(43) Pub. Date: May 11, 2006

(54) Method and device for braking two wheels of a vehicle

(76) Inventors: Juergen Breitenbacher, Winterbach (DE); Andreas Klug, Untergruppenbach (DE); Alfred Strehle, Fellbach (DE); Ono Shunsaku, Kanagawaken (JP)

Correspondence Address: KENYON & KENYON LLP, ONE BROADWAY, NEW YORK, NY, 10004, US

(21) Appl. No.: 10/524,599

(22) PCT Filed: Aug. 5, 2003
(86) PCT No.: PCT/DE03/02623

§ 371 Date: Sep. 22, 2005

(30) Foreign Application Priority Data
Aug. 13, 2002 (DE) 102 37 002.8

(51) Int. Cl. B60T 8/36

(52) U.S. Cl. 303/119.1

(57) ABSTRACT

A method for braking two vehicle wheels of one axle, in which the value of the brake pressure in the wheel-brake cylinder allocated to the first wheel is linked with the value of the brake pressure in the wheel-brake cylinder allocated to the second wheel. The essence of the invention is that the linkage is given via the hydraulic pressure differentials dropping at the respective intake valves.

### FIELD OF THE INVENTION

The present invention relates to a method and a device for braking two vehicle wheels of one axle.

### BACKGROUND INFORMATION

German Published Patent Application No. 42 25 983 describes a method for braking vehicle wheels, in which the brake-pressure build-up at at least one wheel is influenced for reducing a yaw moment generated by an ABS. The brake pressure at the wheels of one axle are influenced in such a way that the difference between the brake pressures of one axle does not exceed a permissible value. This maximum permissible value is made dependent on the vehicle speed and the lateral acceleration.

### SUMMARY OF THE INVENTION

The present invention relates to a method for braking two wheels of a vehicle, in which the value of the brake pressure in the wheel-brake cylinder allocated to the first wheel is linked with the value of the brake pressure in the wheel-brake cylinder allocated to the second wheel.

In this context, the linkage is provided based on the hydraulic pressure differentials decreasing at the respective intake valves.

One advantageous embodiment is characterized in that
the coil current through the specific intake valve is ascertained, and
from this, the pressure differential decreasing at the specific intake valve is determined.

One advantageous refinement is characterized in that, with the knowledge of the pressure differential decreasing at the specific intake valve, the coil current through the specific intake valve is also known. This allows a particularly simple and robust control, since a predefined current can be set substantially more easily than a predefined pressure differential.

One advantageous embodiment is characterized in that
the desired pressure differential dropping at the second of the two intake valves is ascertained from the dropping pressure differential at the first of the two intake valves,
and from this, the coil current needed for generating the desired pressure differential at the second of the two intake valves is ascertained.

As already mentioned, it is possible to set the current needed for the second intake valve in a simple and robust manner.

One advantageous embodiment is characterized in that
the coil current through the first of the two intake valves is ascertained and
from this, the pressure differential decreasing at the first intake valve is determined.

One advantageous specific embodiment is characterized in that the coil current is inferred or ascertained from a characteristic curve characterizing the intake valve. This characteristic curve may be easily stored in a control unit.

One advantageous development is characterized in that the characteristic curve is a curve characterizing the correlation between the decreasing pressure differential and the coil current. Therefore, it involves a valve property. Suitable valves may then advantageously be selected with the aid of the associated characteristic curve.

One advantageous refinement is characterized in that the linkage indicates a maximum value for the difference between the pressure differentials dropping at the respective intake valves. The stipulation of this maximum difference as a secondary condition makes it possible to avoid an excessively strong yaw moment during an ABS braking process.

Another advantageous refinement is characterized in that the linkage indicates the difference between the pressure differentials dropping at the respective intake valves. If the pressure drop at one intake valve is known, the pressure drop at the other intake valve is likewise established by the indication of the difference. An open-loop control instead of a closed-loop control is thereby made possible at this second intake valve. An open-loop control is substantially less costly to implement than a closed-loop control.

One advantageous embodiment is characterized in that the difference between the pressure differentials decreasing at the respective intake valves is a function of the existing driving condition and/or the time. This permits adaptation depending on the situation.

One advantageous specific embodiment is characterized in that the two wheels belong to the same axle.

The device for braking two wheels of a vehicle includes
wheel-brake cylinders allocated to the respective wheel and
intake valves allocated to the respective wheel-brake cylinder.

Moreover, logic means are provided which link the hydraulic pressure differentials decreasing at the respective intake valves.

One advantageous embodiment is characterized in that the logic means are designed so that the pressure differentials are linked via a linkage of the coil currents through the respective intake valves.

Another advantageous embodiment is characterized in that the intake valves are pressure-differential regulating valves.

Further advantageous developments of the present invention are described in the dependent claims. The described specific embodiments of the method are, of course, also suited as specific embodiments of the device and vice versa

### BRIEF DESCRIPTION OF THE DRAWINGS

FIG. 1 shows a wheel brake, as well as an intake valve in the form of a hydraulic circuit diagram.

FIG. 2 shows a clocked triggering of the intake valve.

FIG. 3 shows, in general form, the triggering of an intake valve.

FIG. 4 shows the valve behavior and the reaction of the associated vehicle wheel in response to a triggering of the valve with too high and too low a triggering current.

FIG. 5 shows the valve behavior and the reaction of the vehicle wheel in response to a special triggering for preventing the wheel in question from locking.

FIG. 6 shows the forces and torques acting upon a wheel of the vehicle during a braking operation.

FIG. 7 shows the sequence of the method according to the present invention.

FIG. 8 shows the design of the device according to the present invention.

### DETAILED DESCRIPTION

A hydraulic braking system is described, for example, in German Published Patent Application No. 197 12 889 (which corresponds to U.S. Pat. No. 6,273,525).

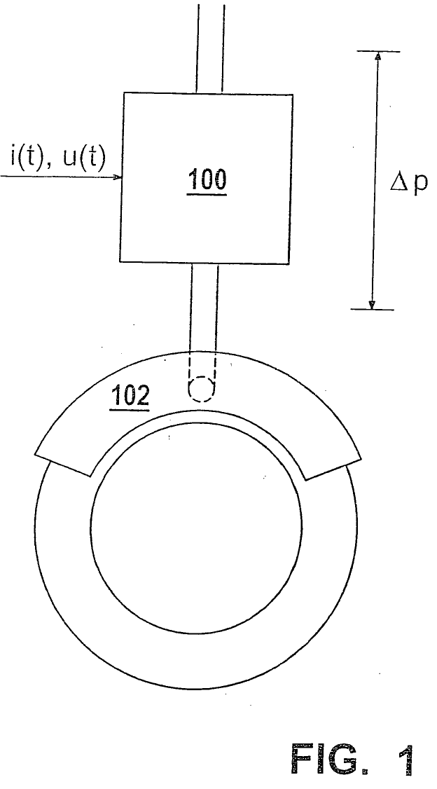

FIG. 1 of the present document shows a segment from a hydraulic circuit. Block 100 identifies an intake valve, block 102 identifies the wheel brake, and Δp identifies the pressure dropping along the intake valve. In this context, the intake valve is triggered via a voltage u(t) or a current i(t).

In the present invention, the intake valve is a pressure-differential regulating valve or a linear solenoid valve (LMV). It has the characteristic that the coil current through the intake valve is proportional to pressure differential Δp decreasing along the intake valve. The intake valve has the two following limiting states:
Given a small coil current, it is open and therefore Δp=0.
Given a large coil current, it is closed and no braking fluid or braking medium is flowing through.

Pressure-regulating intake valves may be characterized by two essential properties:

1. a static correlation between the valve energizing and the adjusted pressure differential (i-Δp-characteristic curve), and

2. a dynamic transient response. This may be described quite well by a first-order time-delay element, the time constant being a function of the connected hydraulic volume.

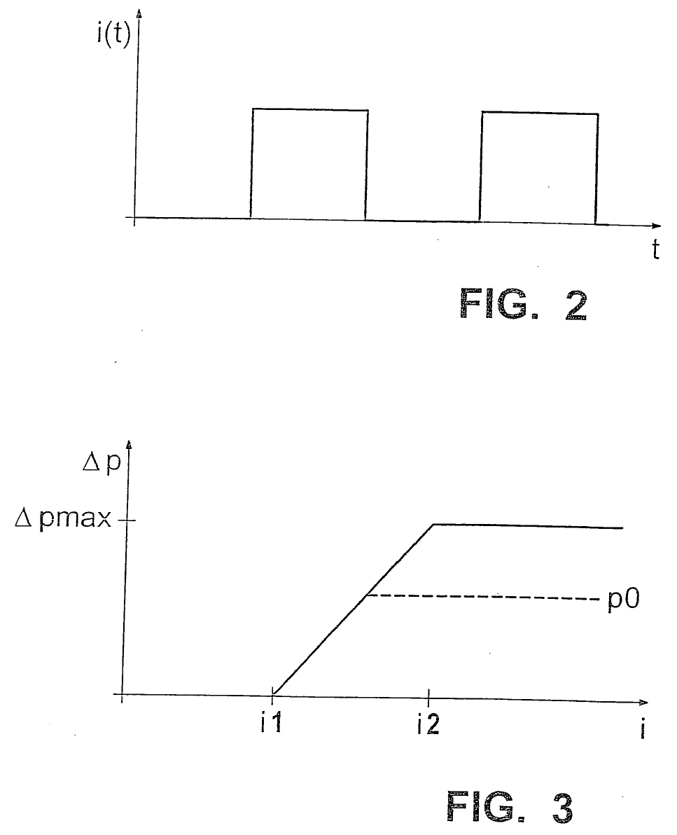

A clocked operating mode of such a valve is shown in FIG. 2. Time t is shown in the abscissa direction and current i(t) is shown in the ordinate direction. In this context, current i(t) changes between a small and a large value; correspondingly, the intake valve changes between the states “open” and “closed”, with negative consequences such as noise generation and high mechanical valve loading.

The characteristic i-Δp curve of an intake valve is shown in FIG. 3. Current i through the coil of the intake valve is shown along the abscissa, and pressure differential Δp to which the intake valve is adjusted is shown along the ordinate. At small currents 0<i<i1, the valve is open and therefore Δp=0. Between i1 and i2, Δp increases in approximately linear fashion. Pressure differential Δp maximally regulable through the intake valve is reached at current i2. Pressure differential Δp is the difference between the pressure at the input of the intake valve and the pressure at the output of the intake valve.

The filling of the wheel-brake cylinder with the braking medium, and therefore the generation of brake pressure is now clarified with reference to FIG. 3.
Initially, the assumption is that the intake valve is closed and the pressure between the feed to the intake valve and the wheel-brake cylinder is p0.
In this case, for example, a current i>i2 would flow.
The intention is now to increase the pressure in the wheel-brake cylinder. This is accomplished by opening the intake valve.
To that end, current i is reduced in ramp-shaped manner over time starting from value i2. In FIG. 3, the state then moves along the broken line to the left.
Pressure differential Δp decreases along the intake valve until that current value is reached at which the broken line intersects the characteristic curve of the intake valve drawn in with a solid line.
The state of the intake valve now moves along the characteristic curve toward the point Δp=0. This point does not necessarily have to be reached. This means clearly that both the current and the pressure differential decrease over time. By taking back the current sufficiently slowly, the valve is operated in static equilibrium. This means that the valve is always in a statically steady-state condition, and the state of the valve moves along the characteristic curve drawn in in FIG. 3.
In this context, the intake valve opens and the pressure in the wheel-brake cylinder increases continuously.

This opening process may be achieved, for example, by a linearly decreasing current ramp.

The movement of the state of the valve along the characteristic curve means that during the pressure build-up in the wheel-brake cylinder, the intake valve is operated exclusively in the statically steady-state condition. Such an operating mode is also known in physics under the heading “adiabatic”: The opening process passes through a sequence of static states.

In this context, it is unimportant whether the energizing of the valve by current stipulation or voltage stipulation is carried out either continually or by pulse/pause triggering. However, the pulse/pause triggering should be of such high frequency that the pressure-differential regulating valve is unable to follow the high-frequency switching operations, but rather follows merely the average value of the pulse/pause triggering. In this connection, advantage is taken of the physical property that the coil current cannot change abruptly.

In addition to the improved switching performance, the described triggering of the valve has the additional advantage that, if the current is known, pressure differential Δp is also known via the i-Δp characteristic curve. This additional information Δp is therefore also available for ABS, ESP or TCS control. (ABS=anti-lock braking system, TCS=traction control system, ESP=electronic stability program)

When using the regulation based on the i-Δp characteristic curve described above, in addition to the point of time of the pressure build-up, there is also the question as to what current triggers the valve at the beginning of the pressure build-up. For this, there are two possibilities:

1. In many vehicle dynamics control systems (for example, ESP), the admission pressure in the brake circuit is known via the sensor system in the vehicle. The instantaneous brake pressure in the wheel-brake cylinder may be calculated using a wheel-pressure model. From the knowledge of the admission pressure and the instantaneous brake pressure in the wheel-brake cylinder, it is possible to calculate the instantaneous pressure differential (decreasing at the intake valve). From this, the necessary opening current may be determined via the i-Δp characteristic curve.

2. In many systems (e.g. in many ABS systems) the admission pressure in the brake circuit is not known. The corrective provided for this case, based on the utilization of the pressure-difference-regulating properties of the intake valves (even without knowledge of the admission pressure) is described in the following.

In the ESP and ABS systems being considered, a pressure build-up always takes place from a pressure-holding phase, that is to say, a phase with constant pressure in the wheel-brake cylinder always precedes a pressure build-up phase (in the wheel-brake cylinder). In the pressure-holding phase, the valve energizing is insignificant, as long as it is just great enough to block the intake valve. Immediately at the beginning of the pressure build-up, a valve current must be set which corresponds to the instantaneously prevailing pressure differential. If this current value is false, then the two following cases result:

Case 1:

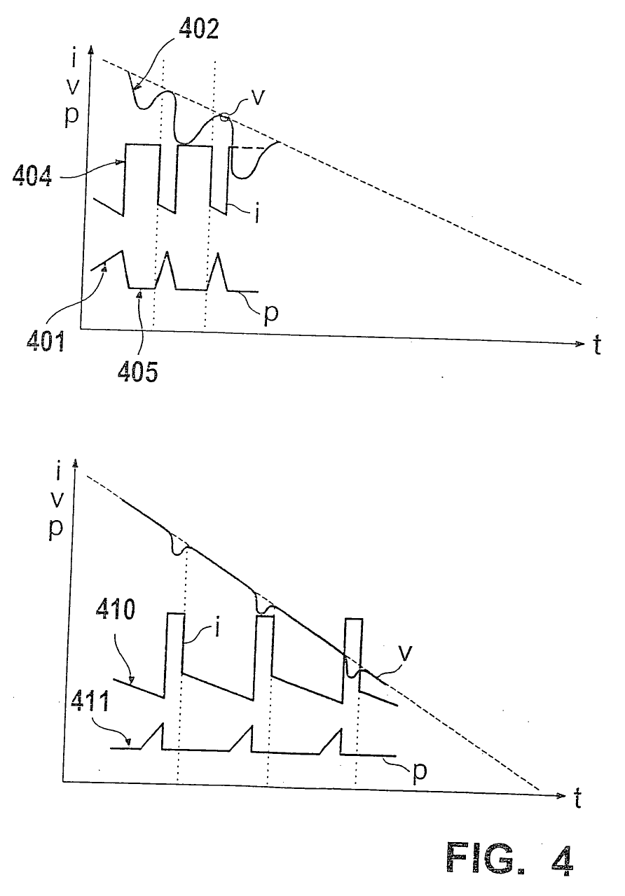

If the current is too small (i.e. the pressure differential dropping at the intake valve decreases very rapidly), then a pressure build-up with unintentionally great build-up gradient takes place. This leads to an irregular control, resulting also in great wheel slippage and a poorly steerable vehicle. This factual situation is represented the upper image of FIG. 4. Time t is plotted in the abscissa direction; valve current i, wheel speed v and pressure p in the corresponding wheel-brake cylinder are plotted in the ordinate direction. Immediately after the current is made, as is apparent at point 401, a rapid pressure build-up takes place. This leads to a correspondingly sharp decline in the wheel speed (402), and as a result thereof, to a response of the ABS control. The ABS control increases the current through the intake valve abruptly (404). This causes the intake valve to close. Therefore, the pressure in the wheel-brake cylinder no longer continues to increase. The (very slow) reduction of pressure in the wheel-brake cylinder is effected by opening the corresponding outlet valve.

Case 2:

If the current is too great, then the pressure build-up is delayed until the valve current (and therefore the maximum blockable pressure differential) and the pressure differential are in equilibrium. During this time, the braking force is too small, and the vehicle is not optimally decelerated. This is shown graphically in the bottom image of FIG. 4, whose axes and drawn-in curves are labeled analogously to the top image. Current i is too great (arrow 410); for that reason, pressure differential Δp is retained too long and not immediately reduced. Therefore, the brake pressure increase in the wheel-brake cylinder first takes place very late (see arrow 411).

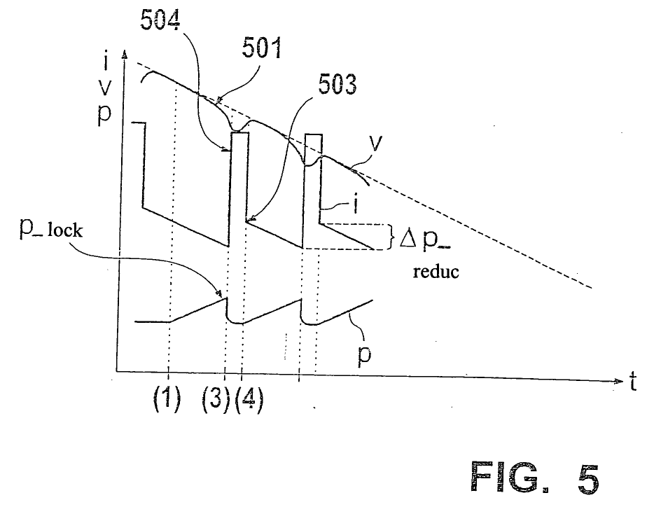

A possible alternative triggering of the intake valve is shown in FIG. 5. The axes are labeled analogously to FIG. 4. The triggering method proceeds in the steps described in the following.

Step 1:

From a pressure-holding phase, the current value is decreased in a ramp shape starting from a value which is initially too high. The balance of forces at the valve is reached at the point of time identified on the time axis by (1); the pressure build-up begins here. This is apparent from the increase of pressure p in the wheel-brake cylinder in the lowest of the drawn-in curves.

It should be emphasized here that this point of time cannot be observed in a system without a wheel-pressure sensor system.

Step 2:

The current is further decreased with a gradient which (imparted via the i-Δp characteristic curve), fulfills the pressure build-up requirements of the ABS controller, however so slowly that the intake valve (as described above) is always in the statically steady-state condition. This phase takes place along the time axis between marked-in points of time (1) and (3).

Step 3:

The lowering of the current leads (as mentioned) to a pressure rise in the wheel-brake cylinder (see increase of p in FIG. 5) and to a growing instability of the wheel. This is expressed in the rapid decrease of the wheel speed, as represented in the curve labeled by v in FIG. 5. Therefore, the curve of wheel speed (v) moves ever further away from the curve (drawn in with a broken line) of the longitudinal vehicle velocity (which is the straight line drawn in as a broken line), as is visible, for example, at point 501. Wheel speed v becomes increasingly smaller compared to the longitudinal vehicle velocity, which means graphically that there is increasing brake slip of the wheel.

The point of maximum longitudinal force is reached at point of time (3); locking pressure p_lock is acting on the wheel-brake cylinder. At the same time, pressure differential Δp_instab decreases at the intake valve. The value of locking pressure p_lock is not known; however, the equation
Δp_instab=p_{—}hz−p_lock
is valid at point of time (3) for pressure differential Δp_instab decreasing along the intake valve.

In this context, p_hz is the pressure in the master brake cylinder. The current associated with pressure differential Δp_instab is known, and therefore pressure differential Δp_instab via the i-Δp characteristic curve.

Step 4:

Because of the instability of the wheels, in the following, a pressure reduction is implemented. This reduction in pressure lasts until the observed wheel dynamics show that the wheel is again becoming stable, that is to say, there is a drop below a slippage threshold. The pressure is reduced by closing the intake valve (via a great valve current, achieved by the rapid current rise 504 in FIG. 5) and opening the outlet valve. A pressure-holding phase subsequently takes place between points of time (3) and (4) (intake valve and outlet valve closed), until the desired point of time for a new pressure build-up is reached. This is point of time (4) in FIG. 5. At this point of time, the wheel behavior is again stable.

Step 5:

For the renewed pressure build-up, first the starting value of the current (503 in FIG. 5) must be ascertained. When ascertaining this starting value, the following assumptions are made:
The coefficient of friction of the road, and therefore the locking pressure were approximately constant within the last regulating cycle.
The admission pressure was approximately constant within the last regulating cycle.
The reduction in the pressure differential dropping at the intake valve by the amount Δp_reduc, which is necessary for stabilizing the wheel, is always approximately constant regardless of the coefficient of friction. Value Δp_reduc (as marked in in FIG. 5) characterizes the pressure differential between the point at which the static operation of the intake valve begins and the point at which the static operation of the intake valve ends. In FIG. 5, variable Δp_reduc is allocated to current curve i. This can be explained in that, during static operation of the intake valve, a linear correlation exists between current i and pressure differential Δp decreasing at the valve.

Thus, the pressure differential dropping at the intake valve at the beginning of the pressure build-up may be ascertained using the equation
Δp_start=Δp_instab+Δp_reduc.

Illustratively, this formula becomes understandable by the explanation that
Δp_instab is the pressure decreasing at the valve in response to commencing instability and
Δp_reduc is the pressure differential by which the pressure dropping at the valve at the beginning of the regulating cycle was reduced as a result of the valve-opening process.
   The starting value of the current in the case of the pressure build-up is yielded again from the i-Δp characteristic curve. Therefore, the method described makes it possible at the beginning of the pressure build-up in the wheel-brake cylinder, to jump quite accurately with the current to that value whose subsequent reduction leads directly to a reduction in the pressure differential dropping at the valve.

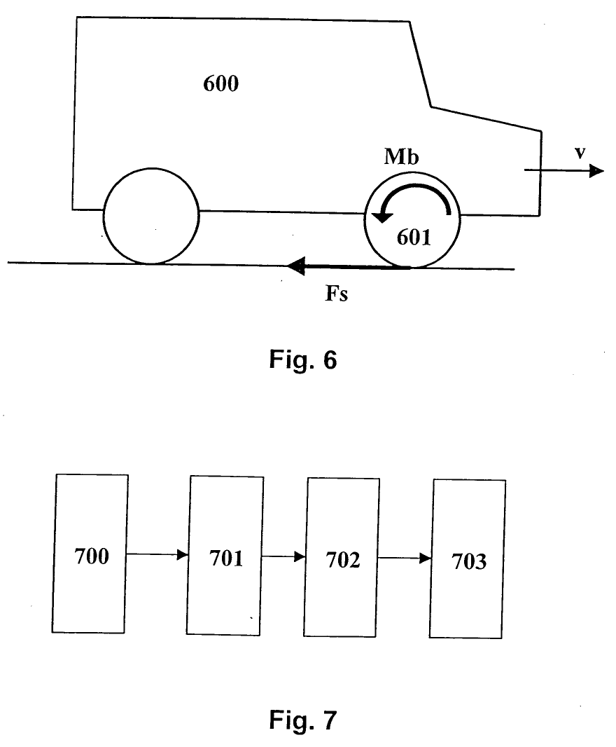

FIG. 6 shows a vehicle 600 moving to the right with velocity v. Let us assume a selected wheel 601 is being considered on the vehicle. Let us say braking torque Mb is acting on this wheel via the vehicle brake. The semicircular arrow drawn in in wheel 602 is the effective direction of braking torque Mb.

The consequences can be made clear based on the following train of thought:
In addition to braking torque Mb, force Fs applied by the road also acts on the wheel.
Braking torque Mb decelerates the wheel, but force Fs counteracts this deceleration.
Force Fs cannot exceed a limiting value which is a function of the tire/road surface contact. If this value is exceeded, the friction immediately changes from static friction to sliding friction: The braking torque can no longer be compensated by force Fs. The result is that the wheel locks.

The physical fundamentals described here are now applied to the case of a vehicle which is moving on a roadway with very different coefficients of friction on the left and on the right (μ-split) and is strongly braked. The ABS system present in the vehicle can now, for example, attempt to adjust the braking force at both wheels to the maximum possible value,
which is small on the vehicle side having the low coefficient of friction and
which is large on the vehicle side having the high coefficient of friction.

Because of the unequal braking forces, a resulting yaw moment develops about the vertical axis of the vehicle. This yaw moment produces a rotational movement of the vehicle in the direction of the higher coefficient of friction, for which the driver must compensate by steering movements. Lowering of the brake pressure on the side having the higher coefficient of friction acts here to promote stability. A pressure should be set here whose amount lies between the pressure on the side having the smaller coefficient of friction (then no yaw moment occurs any longer, but there is only a weak braking) and the maximum possible pressure on the side having the high coefficient of friction (then braking is carried out with maximum intensity, but a strong yaw moment occurs).

The basic idea of the present invention is that at one wheel of the vehicle, the brake pressure is set, for example, according to the regulating method described. In this method, the electric current through the coil of the intake valve is known at any time. This wheel is designated in the following as “regulated wheel”; the other wheel at this axle is designated in the following as “controlled wheel.”

Let us say current i_regulate flows the intake valve of the regulated wheel, pressure differential Δp_regulate decreases at the appertaining intake valve. Pressure differential Δp_control decreasing at the intake valve of another wheel (i.e. the controlled wheel) is controlled on the basis of pressure differential Δp_regulate. The other wheel may be any wheel, but also the other wheel on the same axle as the regulated wheel.

This may be implemented, for example, based on the rule Δp_control=Δp_regulate−pdiff.

Therefore, the value of Δp_control is established, and this desired pressure differential may be adjusted (i.e. controlled) by the current through the associated intake valve.

The following method sequence thus results:

1. Current i_regulate through the intake valve of the regulated wheel is known.

2. Pressure differential Δp_regulate decreasing at the intake valve of the regulated wheel is known via the i-Δp characteristic curve.

3. Pressure differential Δp_control decreasing at the intake valve of the controlled wheel is known, for example, with the aid of a rule Δp_control =Δp_regulate−pdiff.

4. Necessary current i_control through the intake valve of the controlled wheel is known via the i-Δp characteristic curve.

The i-Δp characteristic curve may be different or identical for both intake valves considered.

The value of pdiff may be selected, for example, as a function of time and/or as a function of the driving condition.

For example, it is possible to start with a value pdiff=0 at the beginning of regulating, and then to increase pdiff over time according to a linear function.

In another specific embodiment, it is provided to regulate two wheels (e.g. the two wheels of the same axle) individually with respect to the pressure differential dropping at the intake valve. As a result of the ABS control, the maximum braking force due to the tire/roadway contact is adjusted at each wheel. Particularly given the presence of a μ-split roadway, these braking forces are very different and therefore,
it may be that the shortest braking distance is obtained,
but also an unwanted yaw moment.

Therefore, it is useful here to use an equation
Δp_control=Δp_regulate−pdiffmax
as a secondary condition for regulating the two wheels.

In this context, Δp_control is the pressure differential decreasing at the wheel having the lower coefficient of friction. At the wheel having the higher coefficient of friction, an independent regulating takes place using the secondary condition, that brake pressure Δp_regulate decreasing at the intake valve there is not allowed to exceed the value Δp_regulate_max=Δp_control+pdiffmax. This ensures that at the wheel having the higher coefficient of friction, a higher braking force is also produced; however, the secondary condition prevents too strong a braking-force difference (and therefore too strong a yaw moment).

This solution offers a useful compromise between the achievement of the shortest possible braking distance and the avoidance of a yaw motion.

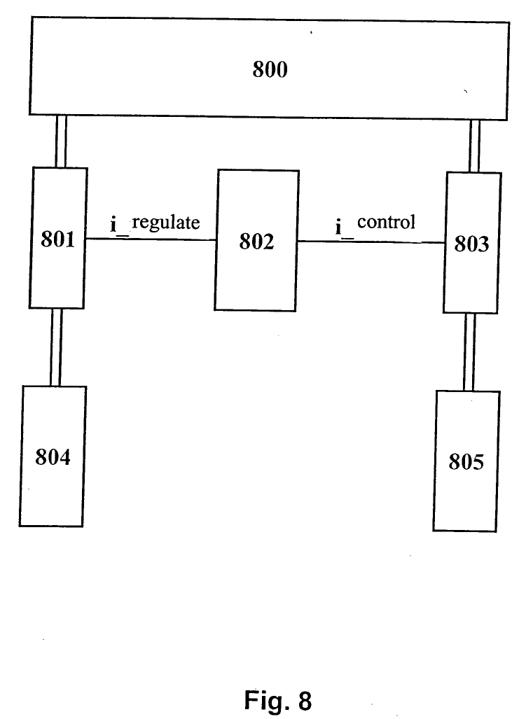

The sequence of the method according to the present invention is shown in FIG. 7. At the start of the method in block 700, current i_regulate through the regulated intake valve is predefined. From this, associated pressure drop Δp_regulate is subsequently ascertained in block 701 with reference to the valve characteristic curve. Pressure drop Δp_control at the controlled intake valve is thereupon ascertained in block 702. Subsequently in block 703, the coil current through the controlled intake valve is therefore also known from the characteristic curve of the controlled intake valve. The design of the device according to the present invention is shown in FIG. 8. Block 802 identifies the logic means which, for example, are in the form of an ABS control unit. Logic means 802 transmit electric currents i_regulate and i_control to intake valves 801 and 802. The double lines (2) are hydraulic lines. Via such lines
intake valve 801 is connected to wheel-brake cylinder 804 and master brake cylinder 800, and
intake valve 803 is connected to wheel-brake cylinder 805 and master brake cylinder 800.

It is thereby possible to control the hydraulic pressure differential decreasing at the respective intake valve via the electric currents.

Naturally, the present invention extends to the braking of three and more wheels of a vehicle. The described braking of one regulated and one controlled wheel may also be extended, for example, to three wheels by considering one regulated wheel and two different wheels controlled (as a function thereof).

1-13. (canceled)

14. A method for braking two wheels of a vehicle, comprising:
linking a first value of a first brake pressure in a first wheel-brake cylinder allocated to a first wheel of the two wheels with a second value of a second brake pressure in a second wheel-brake cylinder allocated to a second wheel of the two wheels, wherein the linking is given on the basis of hydraulic pressure differentials dropping at respective intake valves including a first intake valve and a second intake valve.

15. The method as recited in claim 14, further comprising:
determining a second pressure differential of the hydraulic pressure differentials dropping at the second intake valve from a first pressure differential of the hydraulic pressure differentials dropping at the first intake valve; and
determining, from the second pressure differential, a coil current for generating the second pressure differential.

16. The method as recited in claim 15, further comprising:
determining a coil current through the first intake valve; and
from the coil current through the first intake valve, determining the first pressure differential.

17. The method as recited in claim 16, further comprising:
determining the first pressure differential from the coil current through the first intake valve by evaluating a characteristic curve.

18. The method as recited in claim 15, further comprising:
determining the coil current for generating the second pressure differential from a characteristic curve characterizing the second intake valve.

19. The method as recited in claim 18, wherein the characteristic curve is a curve characterizing a correlation between the second pressure differential and the coil current for generating the second pressure differential.

20. The method as recited in claim 14, wherein the linking indicates a maximum value for a difference between the first pressure differential and the second pressure differential.

21. The method as recited in claim 14, wherein the linking indicates a difference between the first pressure differential and the second pressure differential.

22. The method as recited in claim 21, wherein a difference between the first pressure differential and the second pressure differential is a function of at least one of an existing driving condition and the time.

23. The method as recited in claim 14, wherein the two wheels belong to the same axle.

24. A device for braking two wheels of a vehicle, comprising:
a first wheel brake cylinder allocated to a first wheel of the two wheels;
a second wheel brake cylinder allocated to a second wheel of the two wheels;
a first intake valve allocated to the first wheel brake cylinder;
a second intake valve allocated to the second wheel brake cylinder; and
a logic arrangement for linking a first hydraulic pressure differential dropping at the first intake valve and a second hydraulic pressure differential dropping at the second intake valve.

25. The device as recited in claim 24, wherein the logic arrangement is designed so that the first pressure differential and the second pressure differential are linked via a linkage of a first coil current through the first intake valve and a second coil current through the second intake valve.

26. The device as recited in claim 24, wherein the first intake valve and the second intake valve are differential-pressure regulating valves.
